(19) United States
(12) Patent Application Publication
(10) Pub. No.: US 2012/0040181 A1
(43) Pub. Date: Feb. 16, 2012

(54) HYBRID MOLECULAR MEMORY WITH HIGH CHARGE RETENTION

(75) Inventors: Régis Barattin, Grenoble (FR); Guillaume Delapierre, Vif (FR)

(73) Assignee: COMMISSARIAT A L'ENERGIE ATOMIQUE ET AUX ENE ALT, Paris (FR)

(21) Appl. No.: 13/257,419

(22) PCT Filed: Mar. 16, 2010
(86) PCT No.: PCT/FR2010/000220

§ 371 Date: Oct. 25, 2011

(30) Foreign Application Priority Data
Mar. 18, 2009 (FR) 0901257

(51) Int. Cl. B32B 9/04; B05D 7/24; B32B 33/00; B05D 1/36; B82Y 30/00

(52) U.S. Cl. 428/336; 428/446; 428/447; 427/402; 977/734

(57) ABSTRACT

The invention relates to a silicon substrate functionalised with molecules having redox properties, the production method thereof and a hybrid molecular memory system including same. The silicon substrate includes: a layer of silicon coated on at least one surface with a layer of silicon oxide, said silicon oxide layer being functionalised with R groups having redox properties; and at least one spacer E having one end bound to the silicon oxide layer and one end bound to an R group. The invention is particularly suitable for use in the field of hybrid molecular memory systems.

The invention relates to a silicon substrate functionalized with molecules with redox properties, to a process for manufacturing it and to a molecular memory hybrid system comprising it.

In the face of the limitations encountered in the miniaturization to the nanometer scale of the current flash memories, parallel techniques, such as molecular memory hybrid systems, have come to light. These systems use the advantages of silicon technology while incorporating therein the intrinsic properties of molecular structures. This type of molecular memory device uses the properties of molecules to store information.

More specifically, the writing of data is performed during the oxidation of the redox molecule, and the erasing of data is performed by a reduction reaction of the redox molecule.

One of the main problems encountered in the development of devices of this type is the retention of the charge of the redox molecule on the surface, after the writing of data. This characteristic is in point of fact essential to ensure the storage of the information and to enable the use of this type of system in molecular flash memory.

Increasing the charge retention of a redox molecule by grafting this redox molecule directly onto a silicon oxide layer, itself deposited on a surface of a silicon substrate, has been described in Mathur et al., Properties of functionalized redox-active monolayers in thin silicon dioxide—A study of the dependence of retention time on oxide thickness, IEEE Trans. On Nanotechn., 2005, 4(2), 278-283.

The object of the invention is to further improve the charge retention of the redox molecule on the surface and to limit the dissipation of this charge toward the silicon surface.

To this end, the invention proposes a substrate comprising a silicon layer coated on at least one of its surfaces with a layer of silicon oxide, the silicon oxide layer being functionalized with groups R with redox properties, characterized in that it also comprises at least one spacer E, one end of which is linked to the silicon oxide layer and the other end of which is linked to a group R.

Preferably, the spacer E is a linear or branched C₁ to C₃₀ alkyl chain, optionally comprising heteroatoms, and/or aryl groups, and/or amine functions, and/or ester functions, and/or oxyamine functions, and/or oxime functions, and/or optionally substituted with halogen atoms, the alkyl chain possibly being saturated or unsaturated, on condition that when the alkyl chain comprises unsaturations, it does not comprise conjugated unsaturations allowing electron delocalization over the entire spacer E.

In a first embodiment of the substrate of the invention, the spacer E has the formula I below:

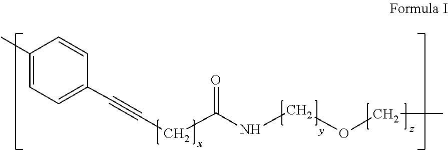

in which 1≦x≦20, 1≦y≦10 and 0≦z≦10 and 2≦x+y+z≦40.

Preferably, in formula I, x=3, y=2 and z=1.

Preferably also, however, in formula I, x=7, y=2 and z=1.

In a second embodiment of the substrate of the invention, the spacer E has the formula II below:

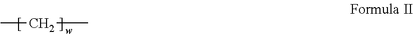

in which 1≦w≦30, advantageously 3≦w≦15.

Preferably, in formula II, w=11.

Preferably also, in formula II, w=7.

Still preferably, in formula II, w=3.

In all the embodiments of the substrate of the invention, preferably, the redox group R with redox properties is chosen from a naphthalene, d nitro-benzene, a hydroquinone, a ferrocene, a porphyrin, a polyoxometallate and a fullerene, and combinations thereof.

Also, in all the embodiments of the substrate of the invention, preferably, the silicon oxide layer has a thickness of between 0.5 nm and 5 nm inclusive.

Preferably, the silicon layer is made of doped silicon.

The invention also proposes a process for manufacturing a substrate according to the invention, characterized in that it comprises the following steps:
a) bonding to a silicon oxide layer deposited on a silicon layer of a spacer E′ of formula III below:

F1_X_F2 Formula III

in which F1 is a reactive group that is capable of bonding to the silicon oxide layer, F2 is a reactive group that is capable of bonding to the reactive group F3 of a redox molecule comprising a redox group R, and X is a hydrocarbon chain,

by reacting the reactive group F1 with the silicon oxide layer, and
b) bonding the spacer E′ to the redox group R by reacting the reactive group F3 with the reactive group F2.

In a first preferred variant of the process of the invention, in formula III, the reactive group F1 is a (C₁-C₃ alkoxy)silane group.

In this case, in a first preferred embodiment of the invention, in formula III, the reactive group F2 is an azide group and the reactive group F3 of the redox molecule is an alkyne group.

In this latter case, preferably, the spacer group E′ has one of the following formulae:

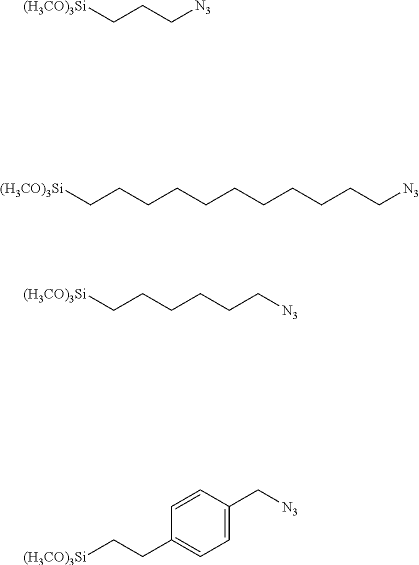

In a second also preferred embodiment of the first variant of the process of the invention, the reactive group F2 is an alkyne group and the reactive group F3 is an azide group.

In a second preferred variant of the process according to the invention, in formula III, the reactive group F1 is a triazene group, which is a precursor of the reactive diazonium function.

In this case, preferably, the reactive group F2 is a COOH group and the reactive group F3 is an NH₂ group.

Still in this case, preferably, the spacer E′ has the following formula:

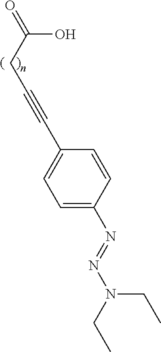

in which n=3 or 7.

Preferably, in the process of the invention, step a) is performed before step b).

However, step b) may also advantageously be performed before step a).

The invention also proposes a molecular memory hybrid system, characterized in that it comprises a silicon substrate according to the invention or obtained via the process according to the invention.

The invention will be better understood and other characteristics and advantages thereof will emerge more clearly on reading the explanatory description that follows.

The invention is based on the discovery that indirect grafting, i.e. grafting via the use of an organic spacer molecule, of a redox molecule onto a surface of a silicon oxide layer placed on a silicon substrate makes it possible to use the device obtained as a molecular memory device with greatly increased charge retention.

Thus, the silicon device or substrate according to the invention is formed from or comprises four components:
a silicon layer,
a silicon oxide layer coating at least one surface of the silicon layer,
a redox group, noted as R hereinbelow, and
a spacer, noted as E hereinbelow, which bonds the redox group to the silicon oxide layer.

In the invention, the following terms have the following meanings:
redox molecule: molecule comprising a redox group R, with reversible oxidation and reduction properties, and a reactive group F3 capable of reacting with a reactive group F2 of the spacer E′ to form a bond. The redox group may be bonded to the reactive group F3 via a hydrocarbon chain, noted as spacer E″ hereinbelow,
redox group R: group that is effectively grafted onto the silicon oxide layer of the substrate of the invention via the spacer E, after reaction of the reactive group F3 with the reactive group F2 of the spacer E′,
spacer E′: precursor of the spacer E formed from a hydrocarbon chain comprising at one end a reactive group F1 capable of bonding to the silicon oxide layer and at another end a reactive group F2 capable of reacting with the reactive group F3 of the redox molecule,
spacer E: organic molecule comprising a hydro-carbon chain, one end of which is bonded to the silicon oxide layer and the other end is bonded to the redox group of the redox molecule; when the redox molecule is composed of the redox group R bonded to the reactive group F3 via a spacer E″, the spacer E is the hydrocarbon chain bonded to the silicon layer and to the redox group R and is thus formed from part of the hydrocarbon chain of the spacer E′ without the reactive group F1, plus the hydrocarbon chain of the spacer E″, these chains being linked together via the chemical group obtained after reacting the reactive group F2 with the reactive group F3,
hydrocarbon chain: linear or branched C₁ to C₃₀ alkyl chain, optionally comprising heteroatoms, such as oxygen, nitrogen or sulfur, and/or aryl groups, and/or amine groups, and/or ester groups, and/or oxyamine groups, and/or oxime groups; the alkyl chain may also be substituted, for example with halogen atoms, such as Cl, F or I; the alkyl chain may also be saturated or unsaturated, but when the alkyl chain is unsaturated, it must not comprise conjugated unsaturations, which may lead to electron delocalization over the entire spacer.

In the four-component system constituting the device of the invention described previously, i.e. in which the redox group R is bonded, indirectly, via the spacer E, to the silicon oxide layer of the substrate of the invention, the spacer E makes it possible to increase the charge retention of the redox group R and to reinforce the positive effect of the increase in charge retention already due to the presence of the silicon oxide layer.

Increasing the charge retention of a redox molecule by grafting this redox molecule directly onto a silicon oxide layer, which is itself deposited on a surface of a silicon substrate, has been described in Mathur et al., Properties of functionalized redox-active monolayers in thin silicon dioxide—A study of the dependence of retention time on oxide thickness, IEEE Trans. On Nanotechn., 2005, 4(2), 278-283.

The study by Mathur et al., was aimed at studying the influence of the thickness of the silicon oxide layer and its effect on the charge retention time.

More specifically, the results of this study show that increasing the thickness of the silicon oxide layer leads to a decrease in electron transfer between the redox center and the silicon surface.

The same effect may be observed on the charge retention time.

However, the charge borne at the surface of the system by the redox center, which is, in this study, a ferrocene, decreases exponentially and rapidly with time.

In this study, the estimated charge retention times, noted as t_{1/2}, are then of the order of about 10 seconds.

In contrast, using a system according to the invention, the retention time increases to more than 2000 seconds.

Furthermore, it is indeed a case here of a synergistic effect between the spacer E and the presence of the silicon oxide layer: when the same spacer and the same redox molecule that are bonded either directly to the surface of the silicon substrate, or directly to the surface of the silicon oxide layer, which is itself placed on the surface of the silicon substrate, are used, the retention time between these two systems (comprising three components in the prior art and four components as in the invention) is itself increased by a factor of at least 10.

The substrate according to the invention is thus formed from a silicon layer, at least one surface of which is covered with a silicon oxide layer, a spacer E being bonded via one end to a surface of this silicon oxide layer and via the other end to a redox group R.

The spacer E used in the invention is any organic spacer that can be bonded to a silicon oxide surface.

In a first preferred embodiment, the spacer E is obtained by grafting onto the silicon oxide surface via a silanization reaction of the spacer E′.

In this case, the spacer E′, which is a precursor of the spacer E, thus preferably comprises, at one end, a (C₁-C₃ alkoxy)silane functionality, and more preferably trimethoxysilane.

This grafting method via a silanization reaction makes it possible to obtain a stable and homogeneous monolayer of spacers, thus having at its surface a usable reactive group, the group F2, for the coupling of the redox group R.

In this case, the spacer E′ is preferably chosen from:

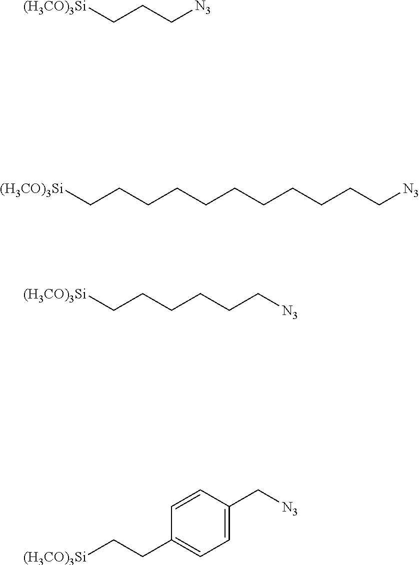

However, as will emerge clearly to a person skilled in the art, many other spacers E may be used.

For example, the spacer E′ may be grafted onto the surface of the silicon oxide layer via phosphonate or phosphate reactive groups F1.

However, it may also be grafted by using spacers comprising, or equipped with, a reactive group F1 that is a diazonium group.

In this case, the spacer E′ comprises at one end a diazonium group or a triazene function which will subsequently be converted into a diazonium group.

The latter case is one preferred embodiment of the invention.

The reactive groups F1 and F2 present at each end of the spacer E′ are separated, for example, by a linear or branched C₁ to C₃₀ alkyl chain, optionally comprising heteroatoms such as oxygen, nitrogen or sulfur. The alkyl chain may also comprise aryl groups, and/or amide functions, and/or ester functions, and/or oxyamine functions, and/or oxime functions.

The alkyl chain may also be substituted, for example with halogens such as Cl, F and I.

The alkyl chain may be saturated or may comprise unsaturations.

However, it is preferable to avoid this alkyl chain comprising conjugated unsaturations, so as not to promote electron transport.

As regards the redox group R, any redox group used in molecular memory hybrid systems may be used.

In the invention, ferrocenes, porphyrins, polyoxo-metallates and fullerenes are most particularly preferred.

However, also, a naphthalene, a nitrobenzene and a hydroquinone may be used, according to the invention.

The coupling of the redox group R to the free end of the spacer E′ will depend on the nature of the reactive group F3 of the redox molecule itself.

For example, a Huisgen cycloaddition may be used when the redox molecule contains at least one alkyne reactive group F3 and when the spacer E′ comprises an azide reactive group F2 at its end.

The reverse may also be performed.

It is also possible to use peptide coupling when the reactive group F2 of the spacer E′ is an NH₂ or COOH group and when the redox molecule itself has a reactive group F3 that is, respectively a COOH or NH₂ group.

More generally, any type of coupling involving the reaction between a nucleophile and an electrophile (thiol/phthalimide, amine/aldehyde, oxyamine/aldehyde, amine/carboxylic acid, etc.) may be used.

The thickness of the silicon oxide layer also has an influence on the increase in the retention time of the redox charge.

As has been stated previously, the more this thickness increases, the more the retention time of the charge of the silicon substrate according to the invention increases.

The thickness of this layer will be from a few angströms to a few tens of a nanometer, and will preferentially be between 0.5 nm and 5 nm and typically between 1 and 2 nm.

As regards the silicon layer itself, several types of silicon may be used, such as p-doped or n-doped silicon, whether they are weakly or strongly doped in each case.

The choice of doping depends on the nature of the chosen redox group R. For the molecules studied in oxidation, redox group R (ferrocene), the silicon will preferably be doped with boron (p doping), i.e. enriched in electron holes. In contrast, for the molecules studied in reduction, redox group R (polyoxometallates), the silicon will have to be strongly enriched in electrons (phosphorus doping, i.e. n doping).

The substrate according to the invention has many advantages.

Firstly, the grafting of the spacers E′, by silanization on silicon oxide, makes it possible to form dense, stable, organized monolayers of spacers E.

This type of functionalization thus makes it possible to achieve high densities of redox groups R on the surface.

Next, the chemical grafting strategy developed allows great flexibility and great choice of functionalization, since several parameters are modifiable. In particular, it has been seen that various spacers E′ could be used in the context of the invention, these spacers E′ having two reactive groups F1 and F2, one of them F1 for grafting onto the silicon oxide layer, and the other for coupling with a redox molecule. Thus, it will be understood that the process used for making a stack as defined above may comprise a first step of grafting onto the SiO₂ layer of the substrate of the invention, followed by subsequent coupling with the molecule with redox properties. However, it may also first comprise coupling of the spacer molecule E′ with the redox molecule R and then grafting of the species obtained onto the silicon oxide surface.

Finally, the introduction of a spacer E between the redox group R and the silicon oxide surface makes it possible to greatly increase the retention time of the charge on the redox center.

It is the cumulative effect of these two factors, the introduction of a spacer E and of a silicon oxide layer, which makes it possible to increase by a factor of 2000 the retention times described in the literature for this type of molecular hybrid memory substrate.

In order to understand the invention more clearly, several embodiments will now be described, for purely illustrative and nonlimiting purposes.

### EXAMPLE 1

Grafting onto a silicon oxide layer of a ferrocene group via an 11-carbon spacer.

In this example, the spacer is first bonded via its methoxysilane group to the silicon oxide layer and the ferrocene molecule is bonded to the spacer thus grafted by reaction of the chlorine reactive group of the spacer E′ with the alkyne reactive group bonded to the ferrocene molecule.

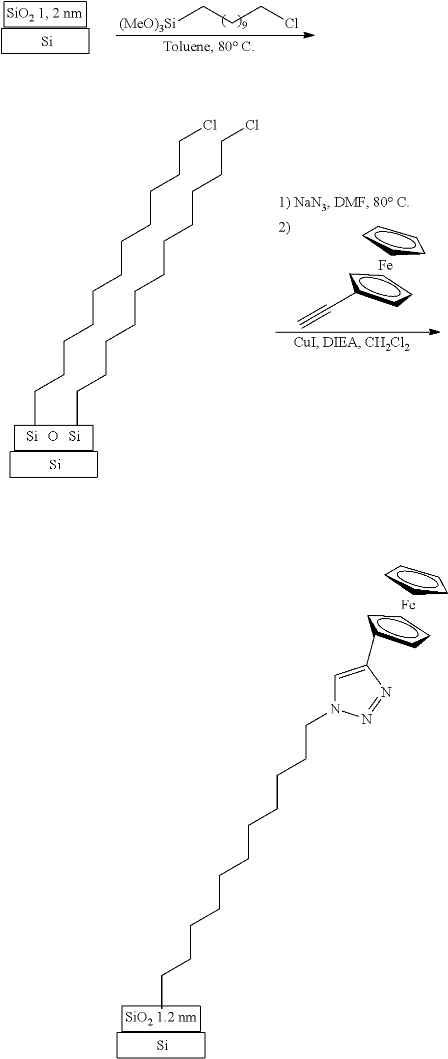

The spacer molecule E′ used is undecyltrimethoxysilane azide, which is obtained, as will be seen below, from 11-chloroundecyltrimethoxysilane.

The surface of a silicon substrate was coated with a layer of silicon oxide 1.2 nm thick.

The grafting of 11-chloroundecyltrimethoxysilane onto the surface of the silicon oxide layer is performed by silanization.

This grafting technique is known and was reported with non-redox systems by Lummerstorfer et al. in Click chemistry on surfaces: 1,3-dipolar cycloaddition reactions of azide-terminated monolayers on silica, J. Phys. Chem. B, 2004, 108, 3963-3966.

Briefly, (MeO)₃Si(CH₂)₁₁—Cl is reacted in toluene, at 80° C. The 11-chloroundecyltrimethoxysilane is then grafted onto the SiO₂ surface.

The end chlorine of the 11-chloroundecyltrimethoxysilane is then converted into azide by treatment with NaN₃ in DMF, at 80° C.

Next, the redox molecule formed from the ferrocene redox group bonded directly to the reactive group F3 is introduced into the mixture in the presence of CuI, DIEA (diisopropylethylamine) and CH₂Cl₂.

The four-component substrate according to the invention is then obtained.

The charge retention time of this system is then measured by the method reported by Mathur et al. in the previously cited article.

The methodology consists in measuring two successive oxidation sweeps, varying the time between these two sweeps.

During the waiting time between these two sweeps, no reduction voltage is applied.

Thus, whereas the first sweep makes it possible to measure all the oxidized charges, the following sweeps measure the charges that have become dissipated from the redox molecule toward the surface.

The time after which a signal corresponding approximately to half the signal obtained during the first oxidation sweep is then measured.

The percentage of charge remaining on the surface as a function of time is thus obtained, which makes it possible to evaluate the charge retention time of the system under study.

With the system of example 1, the charge retention time is 10 000 seconds.

### EXAMPLE 2

Grafting of a ferrocene group onto a silicon oxide layer via the diazonium reactive group of a short-chain spacer.

The spacer E′ used here has a COOH reactive group F2 at one end and an azide reactive group F1 at the other end.

It is obtained from 5-hexynoic acid of the following formula:

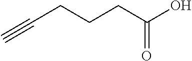

which is first grafted onto the redox molecule that is identical to the one used in example 1, the azide reactive group F1 then being bonded to the alkyne group of 10-undecynoic acid.

Synthesis of the Alkyne Precursor

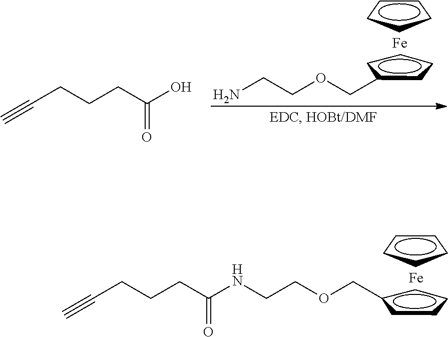

To a solution of 5-hexynoic acid (115 mg, i.e. 1.026 mmol) in 3 ml of anhydrous DMF are added 212 mg of EDC (i.e. 1.106 mmol) and 149 mg of HOBt (i.e. 1.103 mmol). After stirring at room temperature under argon for 15 minutes, 2-aminoethyl-ferrocenyl methyl ether (291 mg, i.e. 1.123 mmol) is added. Stirring is continued for 17 hours. After evaporating off the solvent under vacuum, the residue is redissolved in dichloromethane. The organic phase is washed with water, dried over anhydrous Na₂SO₄, filtered and concentrated under vacuum. The product is purified on silica gel (96/4: DCM/MeOH) and is obtained in the form of an orange oil (227 mg, i.e. 63% yield).

Synthesis of the Ferrocene-Triazene Derivative

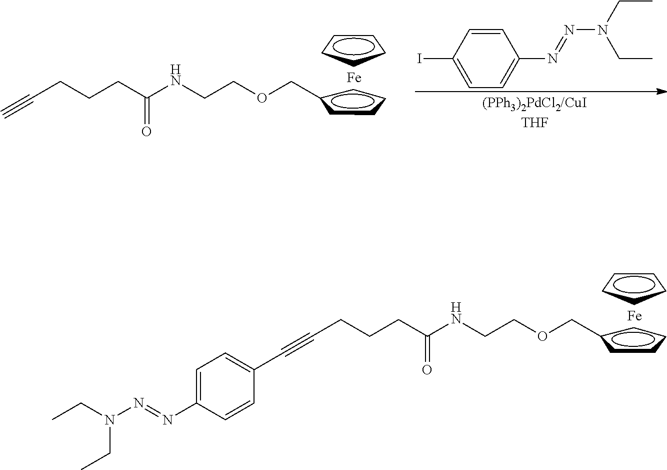

A mixture of iodophenyl-diethyltriazine (82 mg, i.e. 0.270 mmol), of bis(triphenylphosphine)dichloro-palladium(II) catalyst (10 mg, i.e. 0.014 mmol) and of copper iodide CuI (7 mg, i.e. 0.037 mmol) is subjected to three vacuum-argon cycles. After addition of 1 ml of anhydrous tetrahydrofuran and 0.2 ml of triethylamine, a solution of the alkyne precursor (73 mg, i.e. 0.207 mmol) in anhydrous THF (2 ml) is added dropwise. The reaction mixture is then heated at 50° C. under an argon atmosphere for 17 hours. After evaporating off the solvents under vacuum, the product is purified on silica gel (96/4: DCM/MeOH) and is obtained in the form of an orange oil (35 mg, i.e. 32% yield).

Grafting of the Ferrocene Group onto a Silicon Oxide Layer via the Diazonium Group of the Short-Chain Spacer

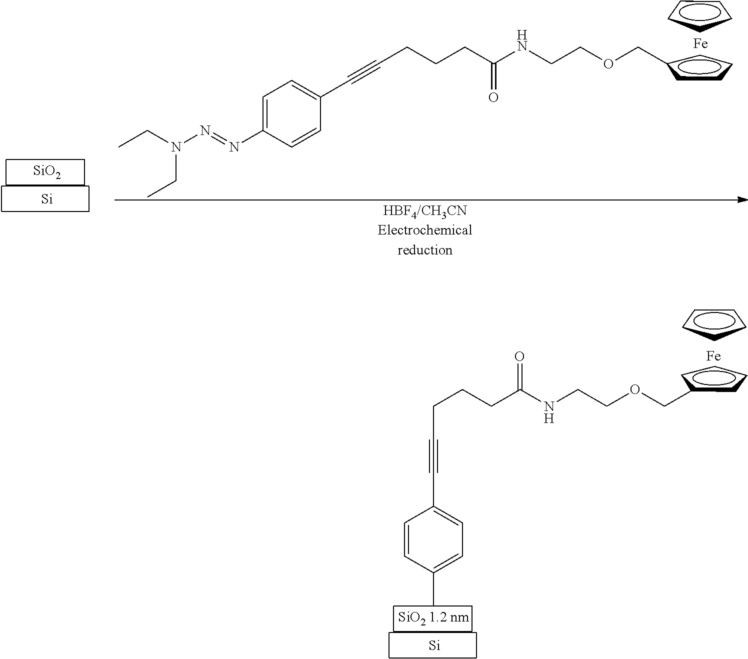

The electrografting is performed using a three-electrode system: the working electrode is the silicon substrate to be functionalized, the reference electrode is a saturated calomel electrode and the counter-electrode is a platinum electrode. The diazonium solution is prepared by adding 40 μl of an 8M solution of tetrafluoroboric acid HBF₄ in water to 5 ml of a 4 mM solution of the ferrocene-triazene derivative and to 0.1M of carrier salt Bu₄NPF₆ in distilled acetonitrile.

The Si—SiO₂ surface is introduced into this diazonium solution. A reduction potential is then applied to the surface (5 reduction sweeps from 0 to −2 V by cyclic voltammetry), allowing the reduction of the diazonium salt on the surface. The surface is then washed and sonicated in dichloromethane and dried under argon.

The Si—SiO₂ substrate is introduced into this diazonium solution. A reduction potential is then applied to the surface (5 reduction scans from 0 to −2 V by cyclic voltammetry), allowing the reduction of the diazonium salt on the surface. The surface is then washed and sonicated in dichloromethane and dried under argon.

With the system of example 2, the charge retention time is 600 s and the associated electron transfer ΔE is 0.471 V.

### EXAMPLE 3

Grafting of a ferrocene group onto a silicon oxide layer via the diazonium reactive group of a long-chain spacer.

The spacer E′ used has a reactive group F2, which is a COOH group, at one end, and a reactive group F1, which is a triazine group, at the other end.

It is obtained from 10-undecynoic acid of formula:

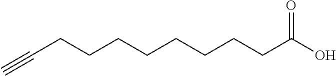

The redox molecule is the same as the one used in example 1.

Synthesis of the Alkyne Precursor

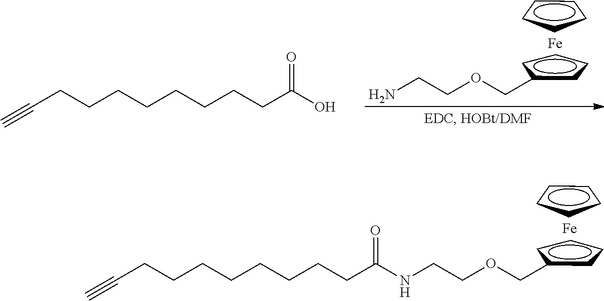

To a solution of 10-undecynoic acid (153 mg, i.e. 0.839 mmol) in 3 ml of anhydrous DMF are added 180 mg of EDC (i.e. 0.939 mmol) and 138 mg of HOBt (i.e. 1.021 mmol). After stirring at room temperature under argon for 15 minutes, 2-aminoethyl-ferrocenyl methyl ether (237 mg, i.e. 0.915 mmol) is added. Stirring is continued for 17 hours. After evaporating off the solvent under vacuum, the residue is redissolved in dichloromethane. The organic phase is washed with water, dried over anhydrous Na₂SO₄, filtered and concentrated under vacuum. The product is purified on silica gel (96/4: DCM/MeOH) and is obtained in the form of an orange-red oil (270 mg, i.e. 76% yield).

Synthesis of the Ferrocene-Triazine Derivative

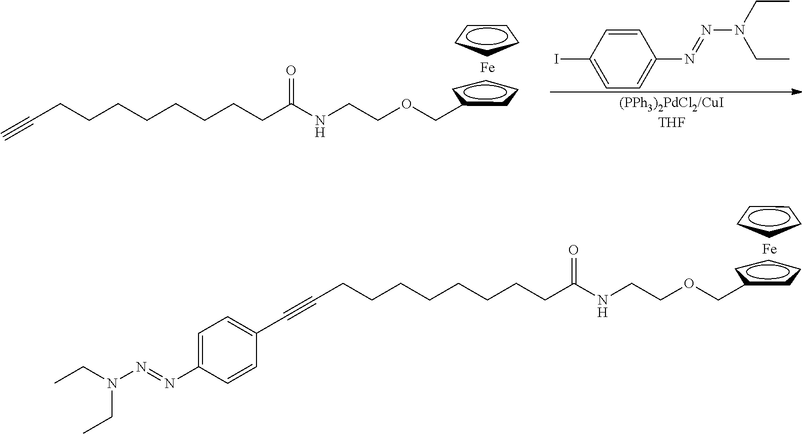

A mixture of iodophenyl-diethyltriazene (110 mg, i.e. 0.363 mmol), of bis(triphenylphosphine)dichloro-palladium(II) catalyst (11 mg, i.e. 0.016 mmol) and of copper iodide CuI (4 mg, i.e. 0.020 mmol) is subjected to three vacuum-argon cycles. After addition of 1 ml of anhydrous tetrahydrofuran and 0.25 ml of triethylamine, a solution of the alkyne precursor (77 mg, i.e. 0.182 mmol) in anhydrous THF (2 ml) is added dropwise. The reaction mixture is then heated at 50° C., under an argon atmosphere, for 20 hours. After evaporating off the solvents under vacuum, the product is purified on silica gel (96/4: DCM/MeOH) and is obtained in the form of an orange oil (25 mg, i.e. 23% yield).

Grafting via the Diazonium Group onto a Silicon Oxide Layer

The grafting is performed on silicon macroelectrodes (p+ doping) covered with an SiO₂ thermic oxide 1.2 nm thick.

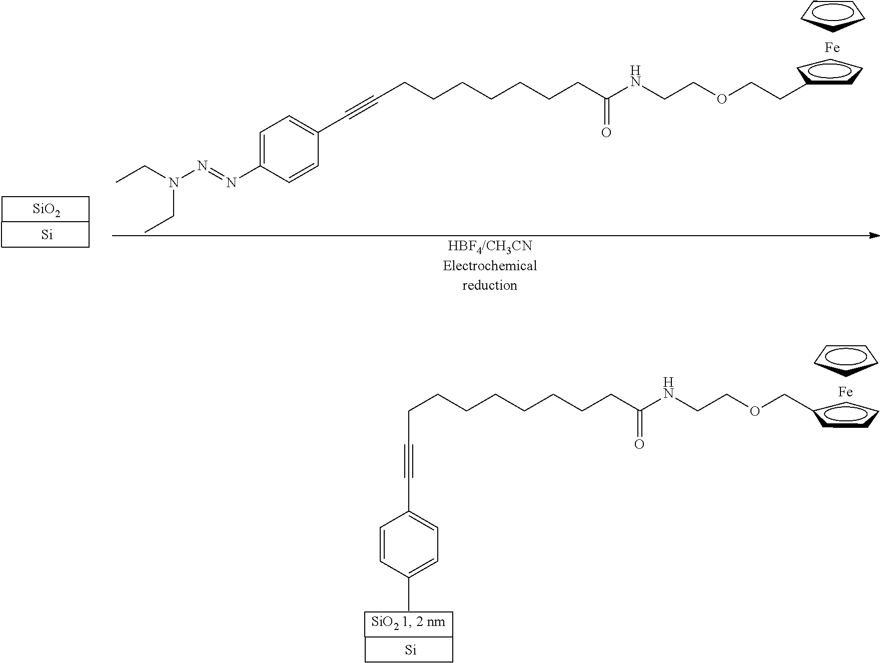

The electrografting is performed using a three-electrode system: the working electrode is the silicon substrate to be functionalized, the reference electrode is a saturated calomel electrode and the counterelectrode is a platinum electrode. The diazonium solution is prepared by adding 40 μl of an 8M solution of tetrafluoroboric acid HBF₄ in water to 5 ml of a 2 mM solution of the ferrocene-triazene derivative and to 0.1M of carrier salt Bu₄NPF₆ in distilled acetonitrile.

The substrate obtained is introduced into this diazonium solution. A reduction potential is then applied to the surface (5 reduction scans from 0 to −2 V by cyclic voltammetry), allowing the reduction of the diazonium salt on the surface. The surface is then washed and sonicated in dichloromethane and dried under argon.

The charge retention time of the system of example 3 is 750 s. The electron transfer associated with this system, ΔE, is 0.922 V.

### COMPARATIVE EXAMPLE 1

Grafting onto a silicon oxide layer of a ferrocene group via the same 11-carbon spacer as in example 1.

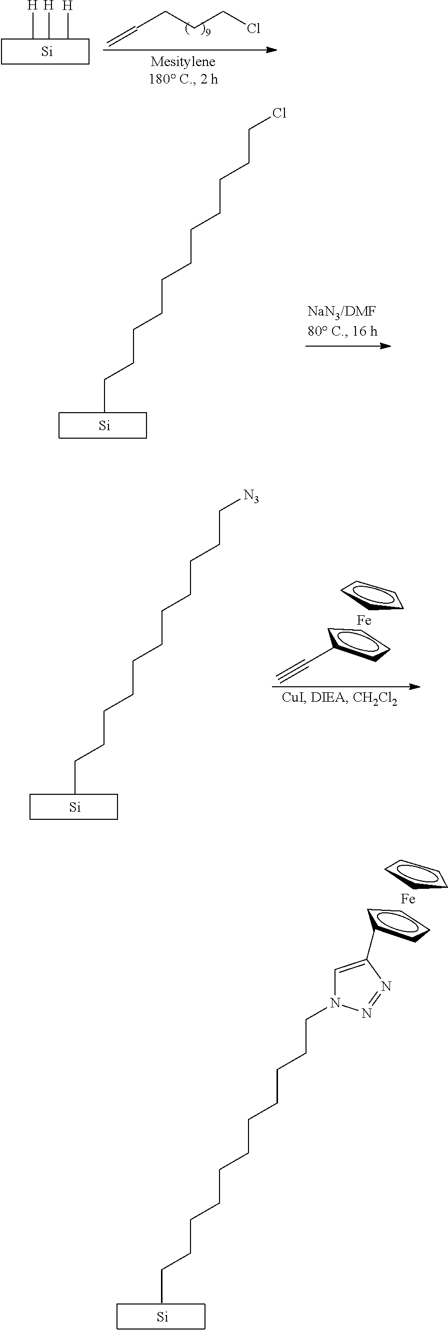

The same spacer E′ and the same redox molecule as in example 1 were used.

However, the substrate used was formed here, solely from silicon.

The grafting of the organic spacer onto the surface of the silicon substrate consisted of the hydrosilylation of the difunctional spacer 11-chloroundec-1-ene, allowing the production of a chloro-terminated monolayer.

This chloro function of the organic spacer is then converted into azide by treatment with sodium azide NaN₃ in DMF.

The azide function is then engaged in a 1,3-cycloaddition reaction with ethynyl-ferrocene, thus allowing the specific and quantitative formation of a triazole and ensuring the coupling of the redox molecule to the surface.

The charge retention time of this three-component system was measured via the same method as in example 1.

The charge retention time, noted as t_{1/2}, of this substrate is about 1000 seconds, i.e. 10 times shorter than with the silicon substrate according to the invention.

### COMPARATIVE EXAMPLE 2

Direct grafting of a ferrocene group onto a silicon layer.

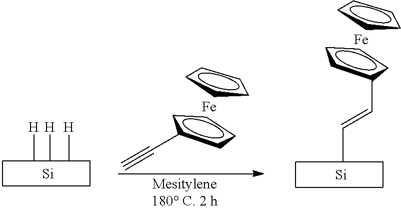

The same redox molecule as in example 1 was grafted directly onto the same substrate as in example 1 formed from a silicon layer.

The values given in the literature by Mathur et al., cited previously were found with this substrate: retention times of about 3 to 5 seconds are obtained, i.e. 2000 times shorter than with the substrate according to the invention.

### COMPARATIVE EXAMPLE 3

Grafting of a ferrocene group onto a silicon layer via the diazonium reactive group of a short-chain spacer.

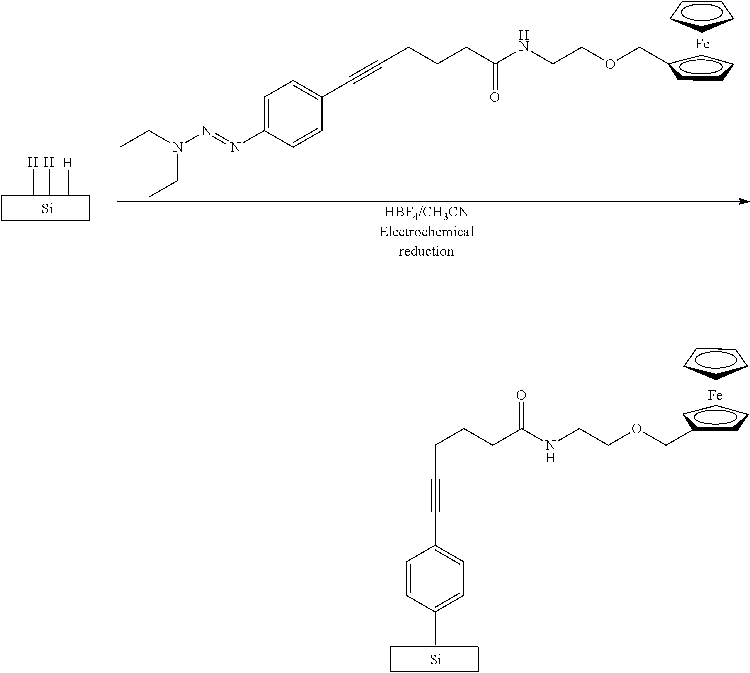

The process was performed as in example 2, except that the substrate used was only formed from silicon.

With this system, the charge retention time is not measurable since the electron transfer associated with this substrate was very low: ΔE=0.135 V.

### COMPARATIVE EXAMPLE 4

Grafting of a ferrocene group onto a silicon layer via the diazonium group of a long-chain spacer.

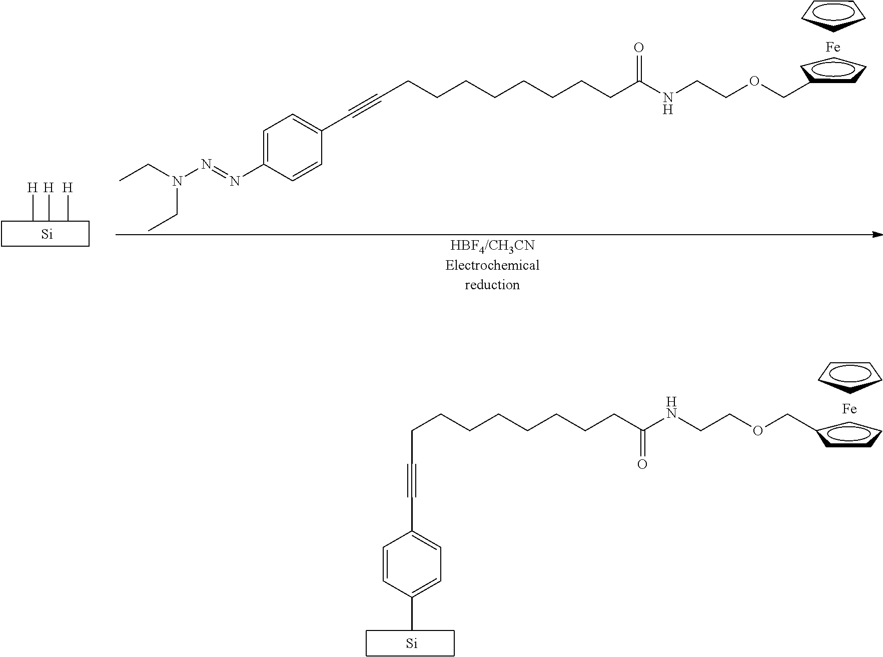

The process was performed as in example 3, except that the substrate used was formed solely from silicon.

The electron transfer ΔE of this system was very low (ΔE=0.201 V), thus making measurement of the charge retention impossible.

It is seen from the preceding examples that with the substrate of the invention, the charge retention time of the redox molecules is increased at least 10-fold.

1. A silicon substrate, comprising:
a silicon layer coated on at least one of its surfaces with a silicon oxide layer, the silicon oxide layer being functionalized with at least one group R with redox properties; and
at least one spacer E, wherein one end of the spacer is bonded to the silicon oxide layer and the other end is bonded to one of the groups R,
wherein the spacer E has a formula (I) 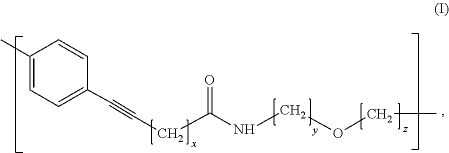
wherein
1≦x≦20,
1≦y≦10,
0≦z≦10, and
2≦x+y+z≦40,
or formula (II): 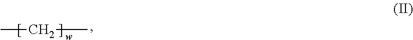
wherein 3≦w≦15.

2. The substrate of claim 1, wherein the spacer E has formula (I), wherein
x=3,
y=2, and
z=1.

3. The substrate of claim 1, wherein the spacer E has the formula (I), wherein
x=7,
y=2, and
z=1.

4. The substrate of claim 1, wherein the spacer E has the formula (II), wherein w=11.

5. The substrate of claim 1, wherein the spacer E has the formula (II), wherein w=7.

6. The substrate of claim 1, wherein the spacer E has the formula (II) wherein w=3.

7. The substrate of claim 1, wherein the group R with redox properties is at least one selected from the group consisting of a naphthalene, a nitrobenzene, a hydroquinone, a ferrocene, a porphyrin, a polyoxometallate, and a fullerene.

8. The substrate of claim 1, wherein the silicon oxide layer has a thickness of between 0.5 nm and 5 nm inclusive.

9. The substrate of claim 1, wherein the silicon layer comprises doped silicon.

10. A process for manufacturing the substrate of claim 1, the process comprising:
(a) bonding to the silicon oxide layer deposited on a silicon layer, at least one spacer E′ of formula (III):
F1_X_F2 (III),
wherein
F1 is a reactive group, capable of bonding to the silicon oxide layer, selected from the group consisting of a (C₁-C₃ alkoxy)silane group and a triazine group,
F2 is a reactive group, capable of bonding to a reactive group F3 of a redox molecule comprising a redox group R, and
X is a hydrocarbon chain,
by reacting the group F1 with the silicon oxide layer; and
(b) bonding the spacer E′ to the redox group R by reacting the reactive group F3 with the reactive group F2.

11. The process of claim 10, wherein the reactive group F1 is a (C₁-C₃ alkoxy)silane group, the reactive group F2 is an azide group, and the reactive group F3 is an alkyne group.

12. The process of claim 11, wherein the spacer group E′ is at least one selected from the group consisting of:

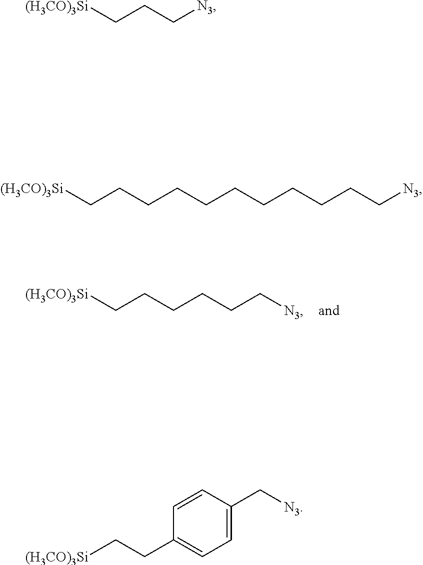

13. The process of claim 10, wherein
the reactive group F1 is a (C₁-C₃ alkoxy)silane group,
the reactive group F2 is an alkyne group, and
the reactive group F3 is an azide group.

14. The process of claim 10, wherein
the reactive group F1 is a triazine group,
the group F2 is a COOH group, and
the group F3 is an NH₂ group.

15. The process of claim 14, wherein the spacer E′ has a formula (IV): 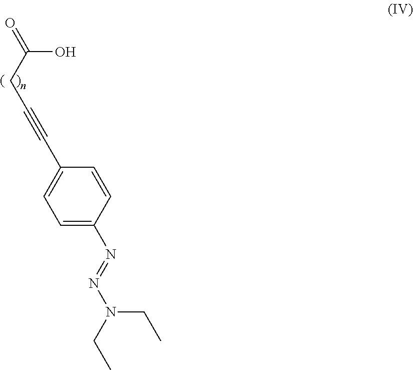
wherein n=3 or 7.

16. The process of claim 10, wherein the bonding (a) is performed before the bonding (b).

17. The process of claim 10, wherein the bonding (b) is performed before the bonding (a).

18. A molecular memory hybrid system, comprising the substrate of claim 1 or obtained a process comprising:
a) bonding to the silicon oxide layer deposited on a silicon layer, at least one spacer E′ of formula (III):
F1_X_F2 (III),
wherein
F1 is a reactive group, capable of bonding to the silicon oxide layer, selected from the group consisting of a (C₁-C₃ alkoxy)silane group and a triazine group,
F2 is a reactive group, capable of bonding to a reactive group F3 of a redox molecule comprising a redox group R, and
X is a hydrocarbon chain, by reacting the group F1 with the silicon oxide layer, and
b) bonding the spacer E′ to the redox group R by reacting the reactive group F3 with the reactive group F2.

19. The substrate of claim 2, wherein the group R with redox properties is at least one selected from the group consisting of a naphthalene, a nitrobenzene, a hydroquinone, a ferrocene, a porphyrin, a polyoxometallate, and a fullerene.

20. The substrate of claim 3, wherein the group R with redox properties is at least one selected from the group consisting of a naphthalene, a nitrobenzene, a hydroquinone, a ferrocene, a porphyrin, a polyoxometallate, and a fullerene.
